(19) United States
(12) Patent Application Publication
(10) Pub. No.: US 2006/0010421 A1
(43) Pub. Date: Jan. 12, 2006

(54) Methods and apparatus for portable object-oriented components

(76) Inventors: Michael N. Gurevich, Walnut Creek, CA (US); Alexey Solofnenko, Concord, CA (US)

Correspondence Address: Michael N. Gurevich, 1422 Whitecliff Way, Walnut Creek, CA, 94596, US

(21) Appl. No.: 11/222,655

(22) Filed: Sep. 9, 2005

Related U.S. Application Data
(63) Continuation of application No. 09/775,112, filed on Feb. 1, 2001, now abandoned.
(60) Provisional application No. 60/179,542, filed on Feb. 1, 2000.

(51) Int. Cl. G06F 9/44

(52) U.S. Cl. 717/107

(57) ABSTRACT

Methods and apparatus are disclosed to facilitate and conduct the programming and implementation of object-oriented computer programs with improved object portability. In one embodiment, a portable component is created that has a pure object for performing desired data processing goals, such as accessing customer account information. The pure object is developed independently of a component system with which it may be deployed. The portable component also has a descriptor block for providing a description of the pure object's capabilities at execution time. The portable component is coupled at runtime with a technology adapter that mediates between the portable component and a particular component system so that the technology-independent portable component can be exercised by requests made to the particular component system. Elements disclosed for providing improved portability of programming objects may be individually, or in combination, provided to system developers and users by various means and methods. For example, the program code representation of a technology adapter may be provided on a transportable storage media such as CD ROM. Program code practicing the present invention makes a user-defined object more resilient to technology change. Because specific information about the component system for deploying the object is not integral to the object itself, a change to the component system does not necessitate a change to the object. Moreover, the same object can be deployed in multiple, disparate component systems simultaneously.

### CROSS-REFERENCES TO RELATED APPLICATIONS

This application claims the benefit of U.S. Provisional Application Ser. No. 60/179,542, entitled “Method and Apparatus for Portable Object-Oriented Components,” dated Feb. 1, 2000, by Gurevich, et al.

### BACKGROUND OF THE INVENTION

1. Field of the Invention

This invention relates to the field of data-processing, in particular to object-based computing.

2. Description of Related Art

It is typical for the programming and development of a large-scale computer application to span a period of two to three years, and for maintenance to span five years or more beyond that. Technologies used in the programming and development of such systems, in contrast, are emerging with a yearly pace. For example, CORBA, DCOM, and enterprise JAVA beans (EJB) component systems became viable alternatives in a period of three years from 1996 to 1998. This discrepancy between life cycles of applications and the technologies used to develop and deploy them is increasing.

The component systems just mentioned all relate to data-processing using object-oriented computer programs. The widespread industry commitment to object-oriented technology stems from the promise of the technology to improve reuse and maintainability of data-processing applications built using object-oriented programs. This promise is undermined, however, where the software objects are constructed with a dependency on the underlying component system. For example, CORBA has a dependency on generated code known as “stub code” on the client side and “skeleton code” on the server side. DCOM has similar dependencies. A programming object having such a dependency cannot be immediately reused in a computing system employing a different component system. Similarly, such an object must be maintained when a different component system is substituted in its home computing system.

Consequently, there is a need in the art for portable programming objects that are resilient to technological change.

### SUMMARY OF THE INVENTION

Methods and apparatus are disclosed to facilitate and conduct the programming and implementation of object-oriented computer programs with improved object portability.

In one embodiment, a portable component is created that has a pure object for performing desired data processing goals, such as accessing customer account information. The pure object is developed independently of a component system with which it may be deployed. The portable component also has a descriptor block for providing a description of the pure object's capabilities at execution time. The portable component is coupled at runtime with a technology adapter that mediates between the portable component and a particular component system so that the technology-independent portable component can be exercised by requests made to the particular component system.

Improved object portability is also facilitated by providing the technology adapter separately. Or, the portable component separately. Various means and methods of such provision are envisioned and disclosed including provision, for example, by transportable storage media.

Program code to facilitate the development and/or implementation of data-processing systems employing the improved portability may advantageously be provided in a generalized form to application developers. Providing such program code aids standardization and reduces the burden on the computer programmer. Portable program code may, of course, also be provided as part of an operational computer system and in many other forms known in the art.

Program code practicing the present invention makes a user-defined object more resilient to technology change. Because specific information about the component system for deploying the object is not integral to the object itself, a change to the component system does not necessitate a change to the object. Moreover, the same object can be deployed in multiple, disparate component systems simultaneously.

These and other purposes and advantages of the present invention will become more apparent to those skilled in the art from the following detailed description in conjunction with the appended drawings.

### BRIEF DESCRIPTION OF THE DRAWINGS

FIG. 1 depicts representative computer technology useful in the practice of the invention.

FIG. 2 depicts a portable component block of the present invention.

FIG. 3 depicts a portable component of the present invention deployed simultaneously for use with two component systems.

FIGS. 4A and 4B depict an embodiment of the present invention using portable structures on both the client and server sides. (FIG. 4 shows the relationship of FIGS. 4A and 4B.)

FIG. 5 depicts a portable component of the present invention deployed simultaneously for use with two component systems, and portable and non-portable client components.

Throughout the figures, a reference numeral in multiple drawings refers to the same element.

### DETAILED DESCRIPTION

The present invention provides for the creation and use of programming objects that are highly portable and resilient to technological change. In the following description, numerous details are set forth in order to enable a thorough understanding of the present invention. However, it will be understood by those of ordinary skill in the art that these specific details are not required in order to practice the invention. Further, well-known elements, devices, process steps and the like are not set forth in detail in order to avoid obscuring the present invention.

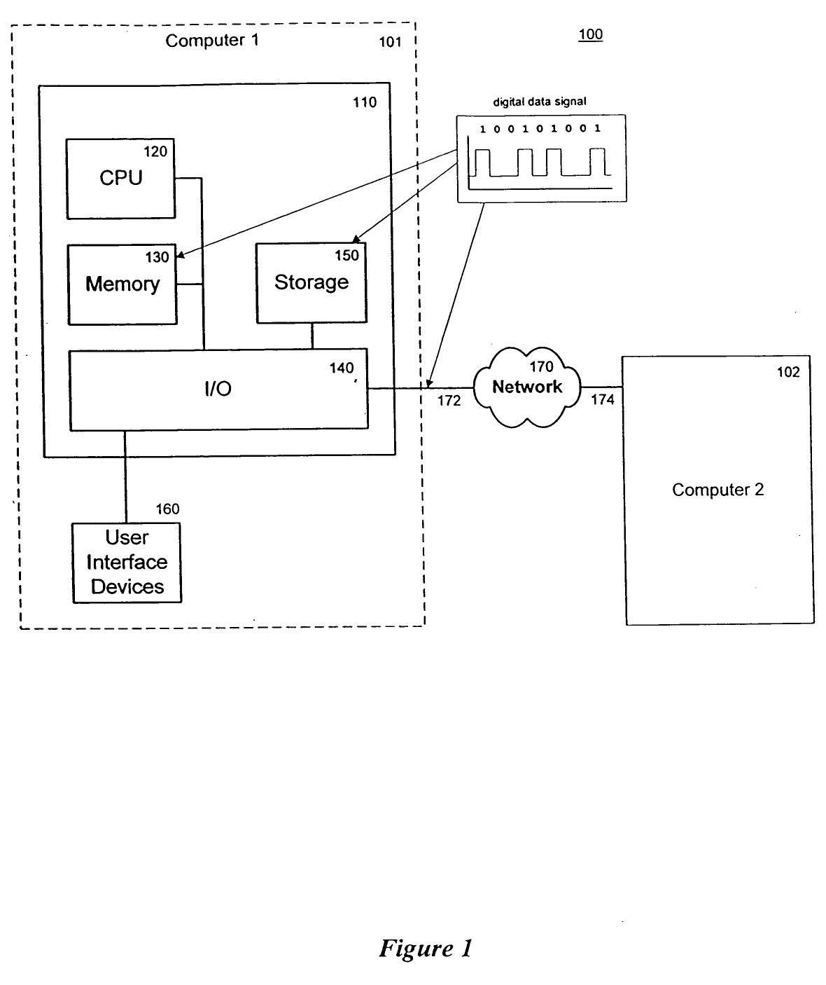

The invention relates to data-processing systems that employ computer programs using object oriented technology. FIG. 1 depicts a representative computer system useful in the practice of the invention. The computer system 100 includes a computer 110 with attached user interface devices 160 and connection 172 to a network 170. The computer 110 has a CPU 120, memory 130, I/O 140, and storage 150.

The CPU 120 executes instructions. The memory 130 holds instructions for the CPU 120 to execute and data to be processed thereby. (Note that, generally, except in regards to their execution, program instructions are handled, treated, and often considered as data.) The memory 130 may include one or more types of memory devices including, but not limited to, RAM, ROM, and flash memory. I/O 140 includes circuitry and devices for providing and receiving data to and from the CPU bus 122—either to and from circuitry and devices included in I/O 140, or to and from circuitry and devices interfaced thereby.

Storage 150 includes circuitry, devices, and media used to hold data. Storage 150 may include one or more device and media types including, but not limited to, fixed disks, removable disks, magnetic tape, CD-ROM, DVD, solid-state memory cards, and magneto-optical disks. Storage 150 is often characterized as holding a large volume of persistent copies of data.

User interface devices 160 includes those devices used to interact with a human user of the computer system. User interface devices 160 may include, without limitation, display screens, keyboards, pointing devices, microphones, and speakers. The network connection 172 permits the computer to interchange data with other computing devices which are themselves attached to the network 170.

The utility of the computer system 100 is in processing data represented in the form of digital signals, e.g., 190. The digital data signal may be persistent, where, for example, the carrier of the digital data signal is a recording media The various media used in storage 150 are such examples. The digital data signal may also be transient, such as in the case of the network connection 172 where the carrier is an electrical current conducted along a wire or cable transmission media, or transmitted through the air.

One skilled in the art recognizes a computer system such as that illustrated in FIG. 1 may be used for both the development and execution of application systems using object-oriented programs and associated component systems. Object oriented computer programs comprise programming objects. The programming object is a logical programming block containing a group of related members. The object may contain method members having program instructions to direct the operation of the computer. Further, the object may contain attribute members. Attribute members may be simple or complex data items and constructs, or other objects.

Further it is well-known in the art that a programming object may exist in multiple forms over its lifetime. For the purposes of application development the definition of the object may exist in the form of class definition source code. Further, the class definition source code for an object is frequently bifurcated into header and implementation files. Further yet, the class definition source code for a specific class may be derived from other definitions using facilities of a particular programming language, such as the template facility commonly found in the C++ language. Templates in C++ permit specific class definitions to ensue from generalized class definitions that are tailored.

For the purposes of application execution the programming object may exist in computer memory as data storage locations holding the object's attribute members, and stored computer instruction sequences to effectuate its method members. One skilled in the art recognizes these and other well-known variations in the representation of a programming object and will understand the practice of the invention to traverse these representations as appropriate.

A programming object may be concealed within a particular computer application program for its exclusive use. A programming object may, however, be included as a resource in a component system (sometimes also referred to as a component subsystem). The component system provides access to the programming object from more than one computer program. A new computer program that needs access to customer account information, for example, may reuse an existing object performing that function, by accessing the object through the component system. An object oriented program resource accessed through a component system is called a component.

The present invention relates to components that are highly portable, i.e., they can be readily moved among differing component systems for deployment.

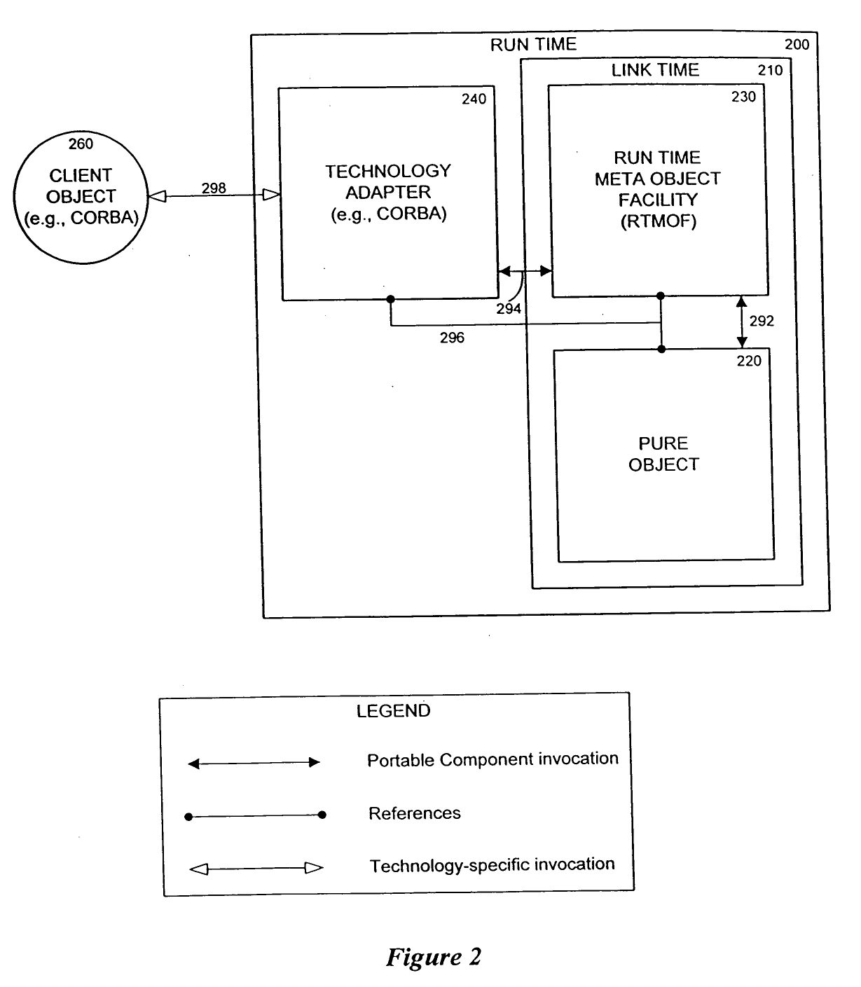

FIG. 2 depicts a portable component block of the present invention. Ported component 200 comprises technology adapter 240 and portable component 210. Portable component 210 comprises describer program block 230 and pure object block 220. Each portable component container 200 further comprises inter-block references 296 and inter-block invocation paths 292, 294. FIG. 2 also depicts a representative technology-specific client object 260 coupled to technology adapter 240 by component system invocation path 298. FIG. 2 depicts a preferred embodiment in a state during program execution after which a component system client object 260 has initiated use of programming resources within ported component 200.

Pure object 220 is a programming object of the type generally defined by an application programmer. The pure object 220 contains attributes and methods as necessary to achieve specific goals of the data processing application system of which it is a part. For example, pure object 220 may include attributes and methods for accessing and presenting customer account information. Pure object 220 does not contain dependencies on the component system associated with invocation path 298.

The definition of the pure object does include, however, an indicator that the object is intended to form part of a portable component. For example, the indicator might be a particularly named method or attribute. Such an indicator poses minimal impact on the size and operation of the object. Moreover, the usefulness of such an indicator is not impaired, nor is the pure object's definition impacted, should component systems in the operating environment change. This is an advantage of the present invention.

The describer program block 230 of the preferred embodiment contains program code to construct a description of pure object 220 in memory during execution. The description includes information about the attribute and method members of pure object 220. Preferably, the describer program block 230 comprises objects defined on an automated basis during program development. The coupling of describer program block 230 and pure object 220 by means of inter-block references 296 and invocations 292 is established at development time. In the preferred embodiment describer block 230 and pure object 220 are coupled at link time to form portable component 210.

Notably, describer block 230 exposes an interface for coupling portable component 210 to technology adapter 240. This is illustrated by the presence of invocation path 294 in FIG. 2.

The purpose of technology adapter 240 is to expose the capabilities of portable component 210 in a technology-specific (component system-specific) way. An instance of technology adapter 240 is bound to portable component 210 at runtime forming ported component 200. Technology adapter 240 exposes an external interface for coupling ported component 200 to an active component system. The presence of this interface is illustrated by invocation path 298. Technology adapter 240 exposes the second interface for coupling with portable component 210. The presence of the second interface is illustrated by invocation path 294.

Notably, technology adapter 240 is specific to the component system with which it interfaces. Technology adapter 240 is, in contrast, generic to the portable components with which it interfaces. This is to say that, in the preferred embodiment, one technology adapter class definition can interface any number of differently defined portable components, i.e., pure objects, with a component system for deployment. If the component system is substituted with another, a new technology adapter needs to be defined. Once defined, the new technology adapter definition is capable of interfacing all of the extant portable components with the new component system. This represents a considerable advantage of the present invention.

In operation, a client object 260 represents capabilities of pure object 220 in the application program of which it is a part (not shown). Client object 260 possesses an interface with a component technology (for example, CORBA) so that at runtime it may access the desired capabilities of a component. When a component capability is needed, client object 260 invokes the component system, establishing invocation path 298. (Invocation path 298 represents the facilities and operation of the component system.) Technology adapter 240 and invocation path 298 become coupled. (Invocation path 298 may, in fact, be responsible for the instantiation of technology adapter 240, depending on the particular component system employed.) Technology adapter 240 fields the request from the component system, locating and possibly initiating the instantiation of portable component 210. Technology adapter 240 couples to describer block 230 to obtain relevant descriptive information about pure object instance 220. The descriptive information could include memory locations used to store data items of the pure object, and memory addresses for instruction sequences that perform the processing of its methods. Technology adapter 240 can then map the inbound request of component system invocation path 298 to the actual pure object instance 220 in memory, process the request, and generate any necessary response in accordance with the requirements of the component system underlying invocation path 298.

It has already been said that if the underlying component system is substituted with another, only a new technology adapter need be defined. The operational description above makes it clear that in a preferred embodiment there is no association of a portable component with a technology adapter before runtime. Accordingly, one skilled in the art will appreciate that changing the underlying component system does not require making changes to extant portable component executables. This represents a further advantage of the present invention so practiced.

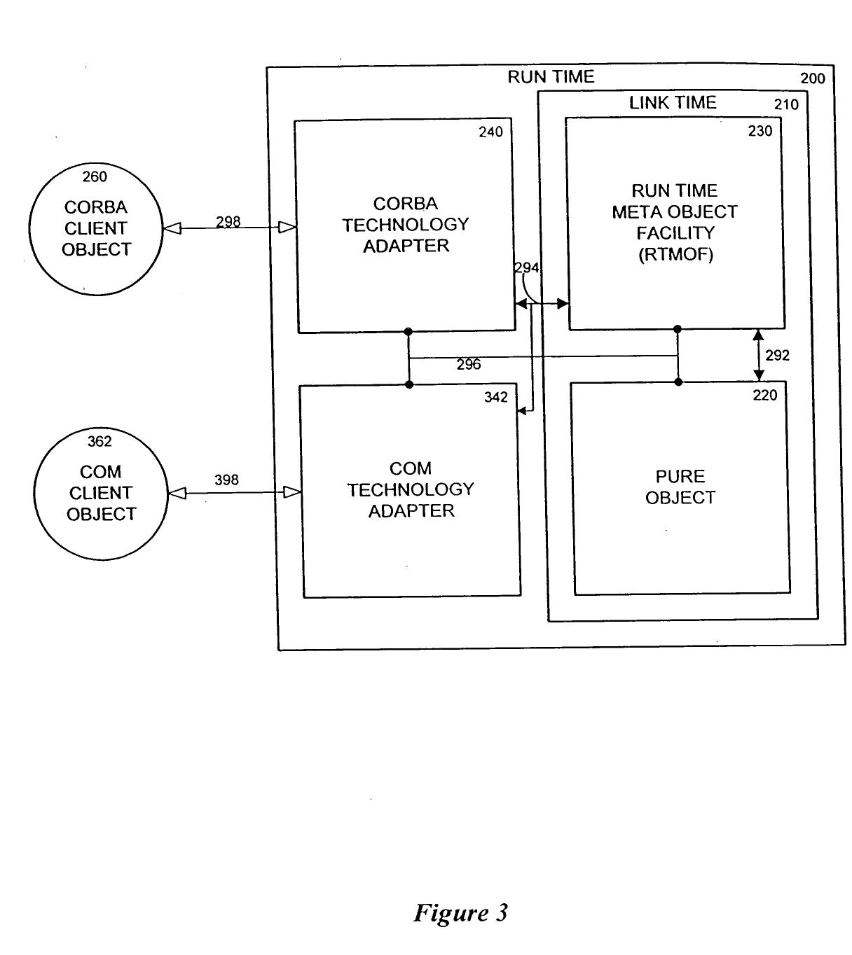

Yet another advantage of the present invention is the ability for a pure object instance of a portable component to be accessed simultaneously by multiple component systems. FIG. 3 depicts a portable component of the present invention deployed simultaneously for use with two component systems.

FIG. 3 duplicates all of the structure depicted in FIG. 2. Ported component 200 comprises technology adapter 240 and portable component 210. Portable component 210 comprises describer program block 230 and pure object block 220. Each ported component 200 further comprises inter-block references 296 and inter-block invocation paths 292, 294. FIG. 3 also depicts a representative technology-specific client object 260 coupled to technology adapter 240 by component system invocation path 298.

In addition to the structure depicted in FIG. 2, FIG. 3 depicts second technology-specific client object 362 coupled to second technology adapter 342 by second component system invocation path 398. Further, inter-block invocation path 294 and inter-block reference path 296 have been extended to show that second technology adapter 342 interfaces to portable component 210, and that it interfaces by the same means as technology adapter 240.

Technology adapters 240, 342 have at least two ways to bind 296 to the pure object 220. In one embodiment, the portable component 210 registers the pure object 220 into naming services accessible by the technology adapters. In another embodiment, the portable component 210 returns references to the pure object 220 to client objects 260, 362.

FIG. 3 depicts a preferred embodiment in a state during program execution after which component system client objects 260, 362 have initiated use of programming resources within ported component 200.

Notably, elements 260, 298, and 240 relate to a specific component system. Here, CORBA is shown as an example. Elements 362, 398, and 342 relate to the different specific component system. Here, COM is shown as an example. The ability for multiple disparate technology adapters, such as 240 and 342, to simultaneously use a singly-defined portable component 210 represents a further advantage of the present invention.

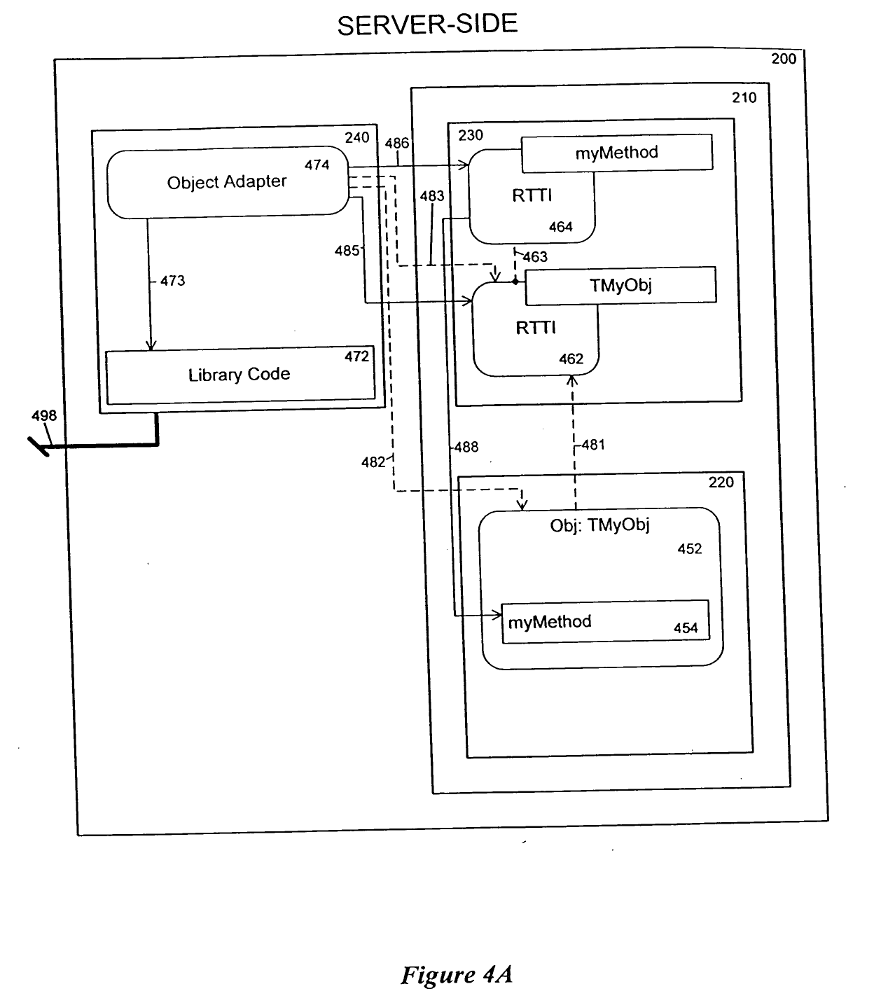

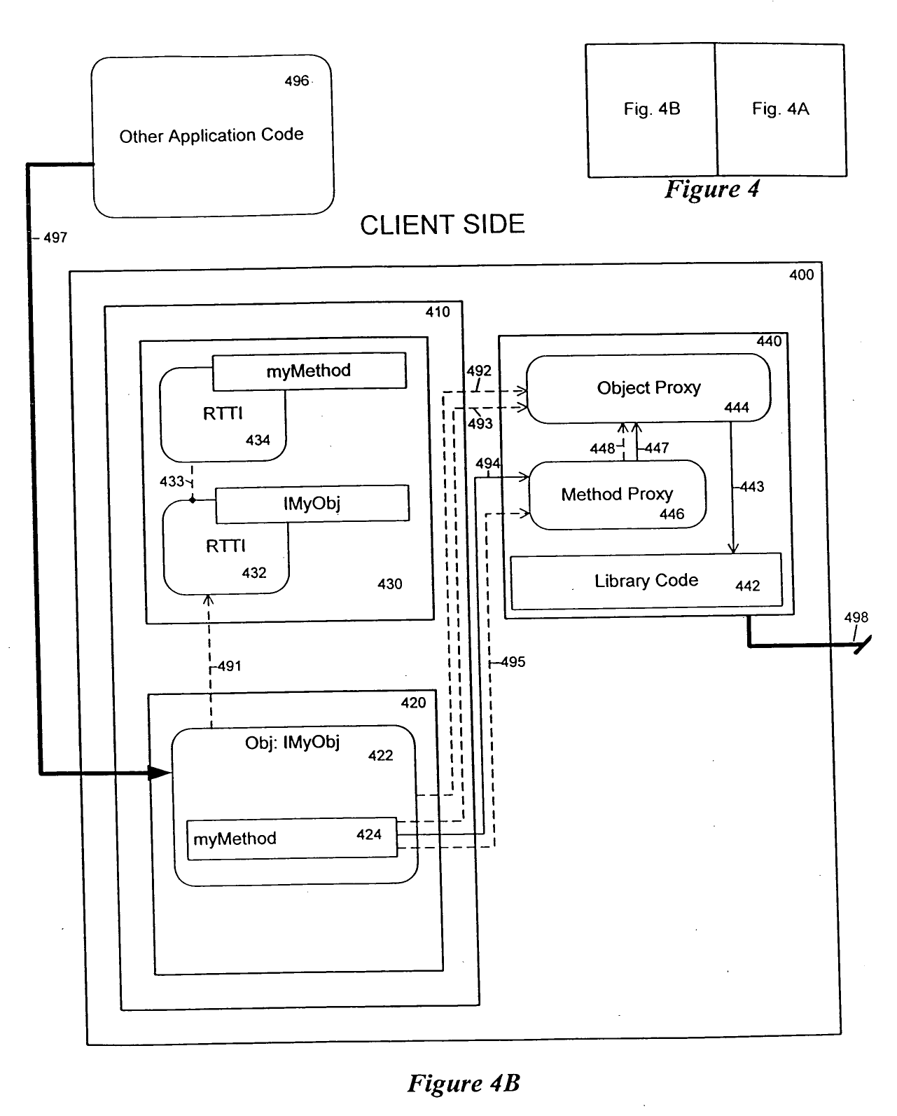

FIGS. 4A and 4B depict a detailed embodiment of the present invention using portable structures on both the client and server sides. A server-side portable component 210, as already discussed in relation to FIGS. 2 and 3, is portable in the sense that it can be deployed under various component systems without the need for internal changes. A more detailed view of the structure of one embodiment of a server-side ported component is shown in FIG. 4A.

FIG. 4A shows a detailed view of a portable component block of the present invention. Ported component 200 comprises technology adapter 240 and portable component 210. Portable component 210 comprises describer program block 230 and pure object block 220. FIG. 4A depicts a preferred embodiment in a state during program execution after which use of programming resources within ported component 200 has been initiated via component system invocation path 498. Invocation path 498 represents the facilities and operation of a component system such as CORBA or DCOM.

In one embodiment, pure object block 220 comprises pure object 452. Pure object 452 comprises member method 454. Describer program block 230 comprises object describer 462, method describer 464, and reference path 463 between them. Technology adapter 240 comprises certain library code 472 of the underlying component system, object adapter 474, and invocation path 473 between them.

Reference path 481 and execution path 488 couple interfaces of pure object block 220 and describer program block 230 with one another. Invocation paths 485, 486 and reference paths 482, 483 couple interfaces of technology adapter 240 and portable component 210 with one another. More specifically, invocation paths 485, 486 and reference path 483 couple interfaces of technology adapter 240 and describer program block 230 with one another; and reference path 482 couples interfaces of technology adapter 240 and pure object block 220 with one another.

With the invocation paths illustrated in this embodiment, the interface at one end comprises the program instructions of a public method of a programming object. The interface at the other end comprises the program instructions to invoke the public method. With the reference paths illustrated, the interface at one end comprises identification of addressable memory locations. The interface at the other end comprises program instructions using the identified addresses of the memory locations as operands.

Particular elements are now discussed in more detail. The role of pure object 452 is to perform data processing activities desired by a system developer. Pure object 452 performs this role by exposing members publicly, for example, a method such as myMethod 454. As part of a portable component 210, the exposed method 454 of pure object 452 will be invoked by method describer object 464. Pure object 452 gains association with method describer object 464 by inclusion in the same program module at link time.

The development-time representation of pure object 452 is created by a system developer. During execution, pure object 452 is instantiated possibly by program code of a program object designed to represent a container for portable component 210. In a preferred embodiment, pure object 452 includes an indicator that it is intended to be part of a portable component.

The role of describer object 462 is to complete a description of the capabilities of pure object 452 available to object adapter 474, so that the pure object can be interfaced to the component system. Describer object 462 performs this role by completing a description of the instance of pure object 452 at execution time and making that description available to object adapter 474 via exposed methods. The description of pure object 452 built by describer object 462 must include information adequate to permit object adapter 474 to interface the pure object with the component system.

In a preferred embodiment, the information in the description completed by describer object 462 includes the types, sizes, names, and locations in memory of attribute members of pure object 452. The description further includes the names, types, parameters, parameter types, results, result types, and locations in memory of method members of pure object 452. Such a comprehensive description makes it likely the describer object 462 could provide all the information about pure object 452 necessary to deploy it under any component system.

Describer object 462 gains association with an object adapter 474 by a procedure executed in technology adapter 240 during object registration.

The development-time representation of describer object 462 can be explicitly coded by a system developer just as with pure object 452. Given the well-defined role of the describer object, and the structured and machine readable format of the representation of the pure object it defines, it is preferable to automate creation of the development-time representation of the describer object. Processing of programming language statements (such as those used to define pure object 452) for system development and integration purposes other than basic compilation is well understood in the art. One such program for processing reads the development-time representation of pure object 452, detects an indicator identifying the object for packaging as a portable component, and generates a development-time representation (such as source code) for describer objects of the portable component. Modifications, including additions, to the source code of the pure object to facilitate self-description could also be made by the processing program.

One skilled in the art recognizes that the descriptive information completed by describer object 462 is readily available from standard source code of object-oriented programming languages or through the execution at runtime of program instructions written in standard source code. For example, a method name is expressly present in source code. And the location in memory of a method member of an object is readily available at runtime using the source code ->* (pointer-to-member) operator of C++, for example. This represents a further advantage of the present invention.

At execution time, describer object 462 is instantiated as a static object. One instance of describer object 462 is instantiated for each type that participates in portable component interfaces (including fundamental types like “int” ward user constructed types like classes of “pure objects”). Describer object 462 may include a list of definitions 454 describing pure object methods 464, a list of attribute definitions of pure object 452, a list of references to describer object 462 of classes derived from the object, and a list of references to the object's parent describer block.

Notably, methods, apparatus and techniques for real-time type identification and self-description for programming objects are extant in the art. For example, Patent Cooperation Treaty patent application, No. PCT US0019909, entitled “Computer Programming Object Externalization,” addresses these topics.

Describer object 462 preferably comprises additional describer objects, for example, describer object 464. As illustrated in FIG. 4A, describer object 462 corresponds to pure object 452, and describer object 464, a member of describer object 462 as illustrated by reference path 463, corresponds to member method 454 of pure object 452.

The role of describer object 464 is to complete a description at runtime of member method 454 of pure object 452. The development-time representation of describer object 464 is created by the manual or automated method for creating describer object 462. During execution, Describer object 464 is instantiated as part of describer object's 462 instantiation. In a preferred embodiment, describer object 464 may include a description of result type, a description of the invocation arguments each including the argument value type, a description of argument passing methods (e.g., by value, by reference, by pointer), argument names, and directions of argument flow (e.g., in, out, inout).

The role of object adapter 474 is to engage library code 472 of a particular component system to receive and process component service requests from that system by engaging a portable component 210. The portable component 210 includes self-description capabilities used by the object adapter 474 to map component service requests to an instantiated object having needed capabilities. Object adapter 474 engages library code 472 by exposing public methods callable by library code 472, by calling public methods exposed by library code 472, or perhaps by containing certain program code from library code 472. The particular method employed will depend in any given implementation on the component system used. In a preferred embodiment object adapter 474 engages library code 472 by exposing public methods callable by library code 472.

In the presently described embodiment object adapter 474 is dynamically instantiated within technology adapter 240 for each pure object 452. Object adapter 474 contains two pointers. One pointer 482 to the pure object instance 452, and another pointer 483 to the describer object 462 of the object's class.

The development-time representation of object adapter 474 is created by a system developer. The definition of object adapter 474 is specific only as to the component system with which it interfaces and is not specific to a particular portable component 210. By using the self describing capabilities of any given portable component the object adapter 474 can acquire the information it needs to deliver the functionality of the portable component's pure object to the component system. During execution, Object adapter 474 is instantiated by technology adapter 240. One instance of object adapter 474 is instantiated for each registered instance of pure object 452 supported by the technology adapter. In one implementation of an object adapter for a CORBA component system, the object adapter may utilize dynamic skeleton interface portions of library code 472 to serve requests from clients.

The role of library code 472 is to permit programming objects to be accessed as components by independent application program code. Such library code is a well-known part of a component system, many of which are in widespread commercial use today. One example is Microsoft's DCOM. Any necessary development-time representation of library code 472 is created by the vendor of the component system and distributed to application developers desiring to deploy their components using the particular component system. The component system vendor may also distribute executables as part of library code 472.

Operation of ported component 200 of FIG. 4A will now be illustrated with an example of a component system call to myMethod 454 of pure object 452. A client application program of the component system initiates a call to myMethod. The call is transmitted using a component technology, such as CORBA or DCOM, represented by invocation path 498 and library code 472. The component system makes a call to object adapter 474 as indicated by invocation path 473. Object adapter 474 looks up the called method's descriptor in object descriptor 462 as indicated by invocation path 485. Based on information obtained from object descriptor 462 the object adapter issues a call into method descriptor object 464 as indicated by invocation path 486. Method descriptor object 464 retransmits the call to target method, myMethod, 454.

Reference path 481 indicates that a pure object of a portable component is coupled to its descriptor block. Reference paths 482, 483 indicate that an object adapter is coupled to a portable component's pure object block and descriptor block. Notably, reference path 482 is untyped to support generic use of the object adapter.

FIG. 4B introduces a detailed view of a component-client structure that can exercise the ported component 200 of FIG. 4A. As such, the component-client structure of FIG. 4B serves the client role in the component system just as the simple client stub objects 260 and 362 suggested earlier in FIGS. 2 and 3. In a preferred embodiment of one aspect of the invention, the component-client does more than simply demanding the capabilities of the server-side pure object using the component system. Rather, it provides certain higher level functionality (e.g., integrity checking), possibly beyond that provided by the component system, by invoking capabilities of an appropriately equipped server-side technology adapter using the component system invocation path directed toward the pure object. The component system is unaware of the dual use of the invocation path as the server-side technology adapter presents its own capabilities and the capabilities of the pure object in undifferentiated form to the component system.

FIG. 4B shows a detailed a view of a portable client requester block usable in the practice of the present invention. Ported requester 400 comprises portable requester 410 and proxy block 440. Portable requester for 10 comprises describer program block 430 and requester object block 420. FIG. 4B depicts a preferred embodiment in the state during program execution after which use of programming resources within a ported component, such as ported component 200 of FIG. 4A, has been initiated via component system invocation path 498. He invocation path 498 represents the facilities in operation of a component system.

In this preferred embodiment, requester object block 420 comprises requester object 422. Requester object 422 comprises member method 424. Describer program block 430 comprises object describer 432, method describer 434, and reference path 433 between them. Proxy block 440 comprises certain library code 442 of the underlying component system, object proxy 444 and invocation path 473 between them. Proxy block 440 further comprises method proxy 446, and reference and invocation paths 448, 447 coupling method proxy 446 with object proxy 444.

Reference paths 492, 493, and 495 couple interfaces of proxy block 440 and requester object block 420 with one another.

Other application program code 496 represents instructions in a computer program that invokes the capabilities of requester object 422 as indicated by invocation path 497. Commonly, the program code of application program code 496 and of portable requester 410 belong to a single computer program. Such a computer program is authored with the intent of using a component system to provide it with program functionality outside of itself. Accordingly, the application program code 496 utilizes requester object 422 as a placeholder for, and access point to, the functionality of a component object such as pure object 452 discussed earlier in reference to FIG. 4A.

Particular elements will now be discussed in more detail. It is apparent that the ported requester block 400 of FIG. 4B is similar to the ported component block 200 of FIG. 4A. library code 442 corresponds to library code 472 but is particularly associated here with the client/requester aspect of the component system. Describer block 430 corresponds to describer block 230 but here is used to complete a description at runtime of a requester object rather than of a pure object. Component system invocation path 498 is unchanged other than here showing the connection at the client/requester side rather than at the server side.

The role of requester object 422 is to provide a type-safe interface and to act on the client side of the component system as a representative of a target object, such as pure object 452. Other application code 496 uses the exposed interface of requester object 422 to invoke methods such as 454 on pure object 452. Other application code 496 gains association with requester object 422 by inclusion in the same program module.

The development-time representation of requester object 422 can be manually coded, or generated using automated means by analyzing some representation of the portable component which the requester object targets. During execution, Requester object 422 could be instantiated by a variety of methods. In one method, the requester object is created as the results of a component system naming service lookup. In this case the pure object is created and registered at execution time prior to the lookup, and the requester object is created as a result of the lookup. In another method, the requester object is created as the results of method invocation returning a reference to an object. In this case the pure object will not be registered with the naming service. Instead, a reference on it is returned to the client component 410, which will create the requester object. One instance of requester object 422 is instantiated for each pure object instance, e.g., 452, invoked by application code 496. In a preferred embodiment, requester object 422 has reference 492 on object proxy 444, a list of method proxies, e.g., 424, each containing a reference 495 to a technology-specific method proxy 446, and possibly a reference 493 to the object proxy 444 of the owner.

The role of object proxy 444 is to transfer a method invocation into the underlying component system. Object proxy 444 performs this role by exposing dynamic invocation interface 447 (e.g., CORBA, or DCOM specific) to method proxies, e.g., 446. Method proxy 446 uses the exposed dynamic invocation interface to make technology-specific invocation 447 from technology independent invocation 494. Object proxy 444 gains association with method proxy 446 during initialization of requester object 422.

The development-time representation of object proxy 444 is a generic class created in the same fashion as technology adapters. During execution, Object proxy 444 is instantiated by technology adapter 440 during requester object 422 initialization. One instance of object proxy 444 is instantiated for each instance of requester object instance 422. In a preferred embodiment, object proxy 444 provides a normalized interface 447 that can be used by method proxy 446. This interface is technology-specific and, for example, an object proxy for a CORBA component system may utilize CORBA DII.

The role of method proxy 446 is to convert technology-independent method invocation 444 into technology-specific request 447. In another embodiment method proxy 446 could directly generate technology-specific request 443 rather than indirectly sending technology-specific request 447 through object proxy 444. Method proxy 446 performs this role by encapsulating technology-specific parameters necessary for converting request 494 into request 447. With a DCOM component system, for example, the method proxy stores Method ID (method number).

The development-time representation of method proxy 446 is a generic class as with the object proxy 444. During execution, Method proxy 446 is instantiated as a static class. One instance of method proxy 446 is instantiated for each method in the class definition for associated requester object 422.

Operation of ported requester block 400 of FIG. 4B will now be illustrated with an example of initiating a component system call to ultimately invoke myMethod 454 of pure object 452 of FIG. 4A. application code block 496 initiates a call to myMethod 424 of requester object 422. Implementation code of myMethod 424 calls corresponding method proxy 446. Library code 442 is then exercised to transmit the request for myMethod 454 of pure object 452 (FIG. 4A) using the component system. In the preferred embodiment method proxy 446 does not exercise library code 442 directly, but rather invokes capabilities of object proxy 444 as indicated by invocation path 447, which in turn invokes library code 442 as indicated by invocation path 443. This indirect invocation of library code 442 is used because it allows a reduction in memory overhead. Specifically, only one method proxy instance is used in a preferred embodiment for all instances of a particular method proxy 424 (i.e., for all myMethod instances). Particular method proxy 424 points to object proxy 444 of its particular owner 422, but to a single, common method proxy 446.

Reference path 492 indicates that a requester object is coupled to its proxy block. Reference paths 493 and 495 indicate that a requester method is coupled to its proxy block.

As between the object adapter and the portable component on the server side, the object proxy block and the portable requester are associated with one another at runtime. One skilled in the art will understand the portability advantages already seen and discussed in relation to components on the server side are thus extended to program code on the client side of the component system that requests component capabilities from the server side of the component system.

In some embodiments practicing the invention, various representations of the various elements depicted in FIGS. 4A and 4B, or various combinations thereof, are rendered in various forms to simplify and facilitate the development and deployment of computing systems that are resilient to technology change through the incorporation of elements that support portability. For example, general or specific definitions for describer objects may be created, stored, and distributed to computer programmers for developing portable components or requesters. And, for example, application code vendors may create, store, and distribute numerous technology adapters along with the components of their system created in portable form.

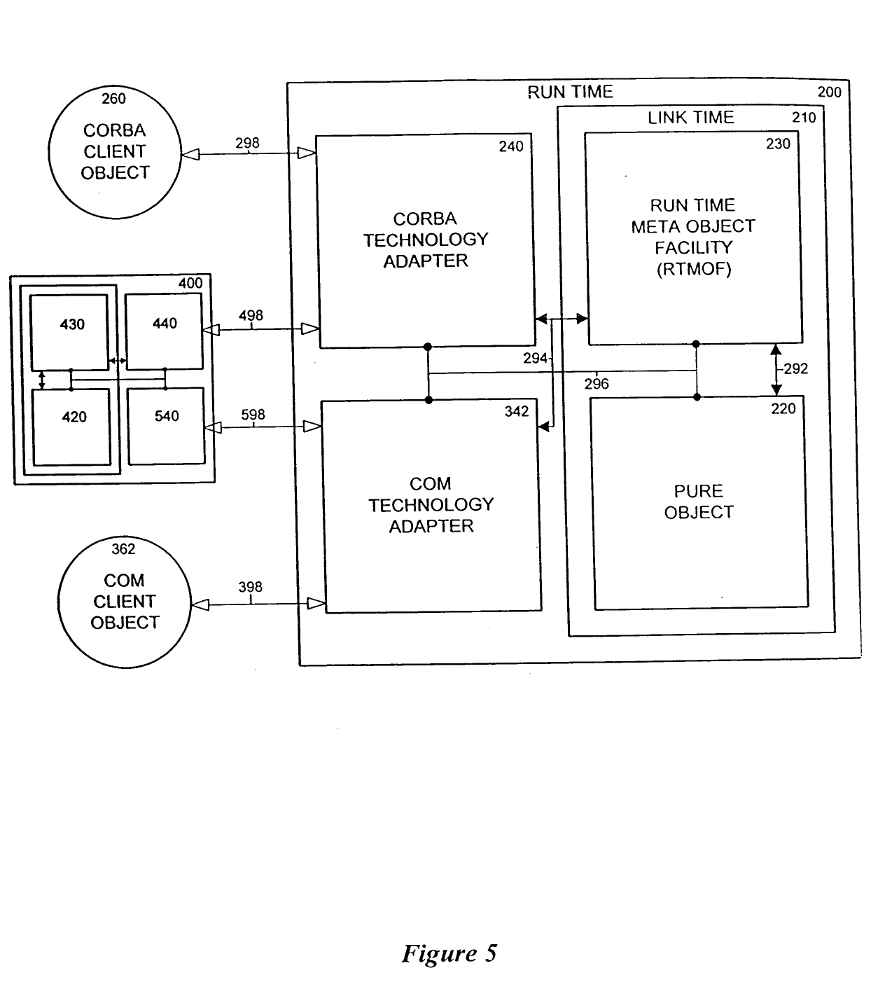

FIG. 5 depicts a portable component of the present invention deployed simultaneously for use with two component systems, and portable and non-portable client components. FIG. 5 illustrates how a portable requester of the present invention and simultaneously work in conjunction with two different component systems, just as for portable components on the server side as discussed earlier in relation to FIG. 3. The earlier description of the elements of FIG. 3 is applicable here and describes many elements of the drawing. What is depicted here beyond that shown in FIG. 3 is now described.

Ported requester block 400 represents the structure of ported requester block 400 of FIG. 4B with the addition of a second proxy block 540. Ported requester proxy block 440, for purposes of illustration, is seen to act as a requester proxy to a CORBA component system. This is indicated by component system invocation path 498 coupling with the CORBA technology adapter 240 of ported component 200. The additional ported requester proxy block 540, for purposes of illustration, is seen to act as a requester proxy to a COM component system. This is indicated by component system invocation path 598 coupling with the COM technology adapter 342 of ported component 200. Accordingly, portable requester 410 can simultaneously work with multiple component systems in the same fashion as portable component 210.

Various modifications to the preferred embodiment can be made without departing from the spirit and scope of the invention. Thus, the foregoing description is not intended to limit the invention which is described in the appended claims in which:

What is claimed is:

1. A method for using a portable component in a computing system having a component subsystem, comprising:
supplying a technology adapter having a first interface for coupling with a component subsystem and a second interface for coupling with a portable component;
supplying a portable component having an interface for coupling with said technology adapter; and
coupling said second interface of said technology adapter and said interface of said portable component.

2. The method of claim 1 wherein said portable component comprises a pure program block and a describer program block.

3. The method of claim 2 wherein said describer program block comprises a program object for representing said pure program block.

4. The method of claim 3 wherein said describer programming block further comprises a program object for representing a member of said pure program block.

5. The method of claim 3 wherein said describer programming block further comprises a program object for representing each attribute member of said pure programming block.

6. The method of claim 3 wherein said describer programming block further comprises a program object for representing each method member of said pure programming block.

7. The method of claim 3 wherein said describer programming block further comprises a program object for representing each member of said pure programming block.

8. A method for simplifying the development of computer programs for a computing system having a component subsystem, and for employing programming objects independent of said component subsystem, comprising:
supplying a technology adapter having a first interface for coupling with a component subsystem, a second interface for coupling with a portable component, and program instructions associated with coupling said second interface.

9. The method of claim 8 wherein said second supplied interface is for coupling with a portable component after execution of a computer program employing said technology adapter has begun.

10. A digital signal carrying medium for simplifying the development of computer programs for a computing system having a component subsystem, and for employing programming objects independent of said component subsystem, comprising:
a digital signal pattern encoding a technology adapter having a first interface for coupling with a component system, a second interface for coupling with a portable component, and program instructions associated with coupling said second interface.

11. The digital signal carrying medium of claim 10 wherein said encoded second supplied interface is for coupling with a portable component after execution of a computer program employing said technology adapter has begun.

12. A computer system for utilizing portable components readily portable for use with varying component subsystems, comprising:
a CPU;
a memory coupled to said CPU comprising stored computer instruction code of a component subsystem and a technology adapter, said technology adapter having an interface for coupling to said component system and having an interface for coupling to an instance of a portable component.

13. The computer system of claim 12 wherein said memory comprises persistent data storage.

14. A. method for constructing a portable component for use in a data processing system having a component subsystem, comprising:
creating a first class definition for a pure object;
creating a second class definition for a describer object associated with said pure object;
constructing an executable file having program code for an object of said first class and an object of said second class.

15. A digital signal carrying medium for simplifying the deployment of computing systems having component subsystems and employing programming objects portable among varying component subsystem types, comprising a digital signal pattern encoding a portable component having been constructed by the method of claim 14.

16. A computer system for utilizing portable components readily portable for use with varying component subsystems, comprising:
a CPU;
a memory coupled to said CPU comprising a portable component having been constructed by the method of claim 14.

17. The computer system of claim 16 wherein said memory comprises persistent data storage.
